(19) United States
(12) Patent Application Publication
(10) Pub. No.: US 2021/0125605 A1
(43) Pub. Date: Apr. 29, 2021

(54) SPEECH PROCESSING METHOD AND APPARATUS THEREFOR

(71) Applicant: LG ELECTRONICS INC., Seoul (KR)

(72) Inventor: Kwang Yong LEE, Suwon-si (KR)

(73) Assignee: LG ELECTRONICS INC., Seoul (KR)

(21) Appl. No.: 16/730,482

(22) Filed: Dec. 30, 2019

(30) Foreign Application Priority Data
Oct. 29, 2019 (KR) 10-2019-0135157

(51) Int. Cl. G10L 15/18; G10L 15/22; G10L 15/16

(52) U.S. Cl. CPC G10L 15/1815; G10L 2015/088; G10L 15/16; G10L 15/22

(57) ABSTRACT

Disclosed is a speech processing method and device that allows a speech processing device, a user terminal, and a server to communicate with one another in a 5G communication environment by performing speech processing by executing mounted artificial intelligence (AI) algorithms and/or machine learning algorithms. The speech processing method according to an exemplary embodiment of the present disclosure may include generating a keyword mapping text in which a plurality of words are respectively mapped to preset keywords by using user utterance text consisting of the plurality of words as an input, generating attention information about each of the keywords by inputting the keyword mapping text into an attention model, and outputting two or more utterance intents corresponding to the user utterance text by using the attention information.

### CROSS-REFERENCE TO RELATED APPLICATION

This present application claims the benefit of priority to Korean Patent Application No. 10-2019-0135157, entitled “Speech processing method and apparatus therefor” filed on Month Oct. 29, 2019, in the Korean Intellectual Property Office, the entire disclosure of which is incorporated herein by reference.

### BACKGROUND

### 1. Technical Field

The present disclosure relates to a speech processing method and apparatus in which speech processing is performed by executing mounted artificial intelligence (AI) algorithms and/or machine learning algorithms.

### 2. Description of Related Art

As technology continues to advance, various services using speech recognition technology have been introduced in a number of fields in recent years. Speech recognition technology can be understood as a series of processes of understanding utterances spoken by a speaker and converting the spoken utterance to text data recognizable and usable by computers. Furthermore, the speech recognition services using such speech recognition technology may include a series of processes for recognizing a user's spoken utterance and providing a service appropriate thereto.

The above-described background technology is technical information that the inventors hold for the derivation of the present disclosure or that the inventors acquired in the process of deriving the present disclosure. Thus, the above-described background technology may not necessarily be regarded as known technology disclosed to the general public prior to the filing of the present application.

### SUMMARY OF THE INVENTION

The present disclosure is directed to accurately analyzing an utterance intent of a user included in a spoken utterance of the user.

The present disclosure is directed to analyzing two or more utterance intents from a spoken utterance of a user including two or more commands for operating an electronic device, and providing a speech processing service corresponding to the analyzed two or more utterance intents.

The present disclosure is directed to analyzing two or more utterance intents by using a result of respectively mapping a plurality of words to preset keywords from a user utterance text consisting of the plurality of words.

The present disclosure is directed to analyzing two or more utterance intents by applying a result of respectively mapping a plurality of words to preset keywords from a user utterance text consisting of the plurality of words, and attention information about the keywords.

A speech processing method according to an exemplary embodiment of the present disclosure may include outputting a plurality of utterance intents by applying keyword mapping and attention information to an utterance text of a user including two or more commands for operating an electronic device.

Specifically, the speech processing method according to this embodiment of the present disclosure may include generating a keyword mapping text in which a plurality of words are respectively mapped to preset keywords by using a user utterance text consisting of the plurality of words as an input, generating attention information about each of the keywords by inputting the keyword mapping text into an attention model, and outputting two or more utterance intents corresponding to the user utterance text by using the attention information.

Through the speech processing method according to this embodiment of the present disclosure, two or more utterance intents may be analyzed from a spoken utterance of a user including two or more commands for operating an electronic device, and the electronic device may be operated in response to the analyzed two or more utterance intents. Accordingly, speech processing performance may be improved.

A speech processing apparatus according to another exemplary embodiment of the present disclosure may include an encoder configured to generate a keyword mapping text in which a plurality of words are respectively mapped to preset keywords by using a user utterance text consisting of the plurality of words as an input, an attention information processor configured to generate attention information about each of the keywords by inputting the keyword mapping text into an attention model, and a decoder configured to output two or more utterance intents corresponding to the user utterance text by using the attention information.

A speech processing apparatus according to still another exemplary embodiment of the present disclosure may include one or more processors, and a memory connected to the one or more processors. The memory may store a command configured to cause generation of a keyword mapping text in which a plurality of words are respectively mapped to preset keywords by using a user utterance text consisting of the plurality of words as an input, obtaining of attention information about each of the keywords by inputting the keyword mapping text into an attention model, and output of two or more utterance intents corresponding to the user utterance text by using the attention information.

In addition, other methods and other systems for implementing the present disclosure, and a computer-readable recording medium storing computer programs for executing the above methods may be further provided.

The above and other aspects, features, and advantages of the present disclosure will become apparent from the detailed description of the following aspects in conjunction with accompanying drawings.

According to the present disclosure, the utterance intent of the user included in the spoken utterance of the user may be accurately analyzed, thereby improving speech processing performance.

Further, the two or more utterance intents may be analyzed from the spoken utterance of the user including the two or more commands for operating the electronic device, and the electronic device may be operated in response to the analyzed two or more utterance intents, thereby improving speech processing performance.

Further, the two or more utterance intents may be analyzed by using a result of respectively mapping the plurality of words to the preset keywords from the user utterance text consisting of the plurality of words, thereby improving speech processing performance.

Further, the two or more utterance intents may be analyzed by applying a result of respectively mapping the plurality of words to the preset keywords from the user utterance text consisting of the plurality of words, and the attention information about the keywords, thereby improving speech processing performance.

Further, even though the speech processing apparatus itself is a mass-produced uniform product, the user may recognize the speech processing apparatus as a personalized device, such that an effect as a user-customized product may be achieved.

Further, when various services through speech recognition are provided, satisfaction of the user may be increased, and prompt and accurate speech recognition processing may be performed.

Further, a voice command intended by the user may be recognized and processed using only optimal processor resources, thereby improving power efficiency of the speech processing apparatus.

The effects of the present disclosure are not limited to those mentioned above, and other effects not mentioned can be clearly understood by those skilled in the art from the following description.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

FIG. 1 is an exemplary view of a speech processing environment including an electronic device including a speech processing apparatus according to an exemplary embodiment of the present disclosure, a server, and a network connecting the above-mentioned components.

FIG. 2 is a schematic block diagram of a speech processing apparatus according to an exemplary embodiment of the present disclosure.

FIG. 3 is a schematic block diagram of an information processor according to an exemplary embodiment of the speech processing apparatus of FIG. 2.

FIG. 4 is a schematic block diagram of a natural language understanding unit according to an exemplary embodiment of the information processor of FIG. 3.

FIG. 5 is an exemplary view illustrating setting of information stored in a second database of the information processor of FIG. 3.

FIG. 6 is a flowchart illustrating a speech processing method according to an exemplary embodiment of the present disclosure.

### DETAILED DESCRIPTION

Advantages and features of the present disclosure and methods of achieving the advantages and features will be more apparent with reference to the following detailed description of example embodiments in connection with the accompanying drawings. However, the description of particular example embodiments is not intended to limit the present disclosure to the particular example embodiments disclosed herein, but on the contrary, it should be understood that the present disclosure is to cover all modifications, equivalents and alternatives falling within the spirit and scope of the present disclosure. The embodiments disclosed below are provided so that this disclosure will be thorough and complete and will fully convey the scope of the present disclosure to those skilled in the art. In the interest of clarity, not all details of the relevant art are described in detail in the present specification in so much as such details are not necessary to obtain a complete understanding of the present disclosure.

The terminology used herein is used for the purpose of describing particular example embodiments only and is not intended to be limiting. It must be noted that as used herein and in the appended claims, the singular forms “a,” “an,” and “the” include the plural references unless the context clearly dictates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or a combination thereof. Furthermore, these terms such as “first,” “second,” and other numerical terms, are used only to distinguish one element from another element. These terms are generally only used to distinguish one element from another.

Hereinbelow, the example embodiments of the present disclosure will be described in greater detail with reference to the accompanying drawings, and on all these accompanying drawings, the identical or analogous elements are designated by the same reference numeral, and repeated description of the common elements will be omitted.

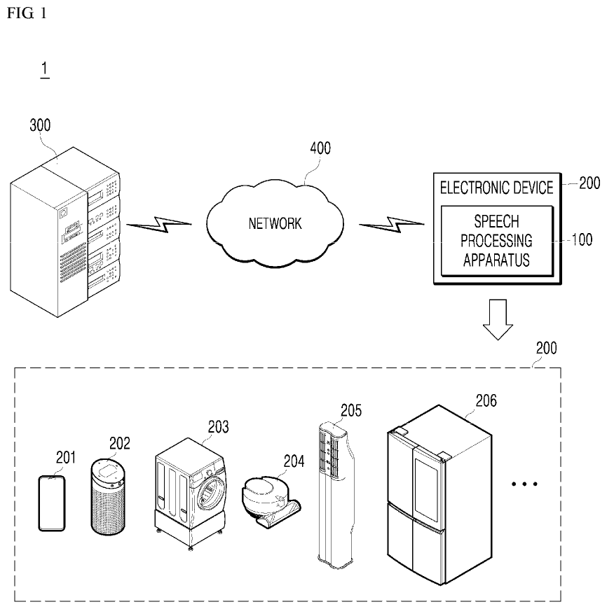

FIG. 1 is an exemplary view of a speech processing environment including an electronic device including a speech processing apparatus according to an exemplary embodiment of the present disclosure, a server, and a network connecting the above-mentioned components. Referring to FIG. 1, the speech processing environment 1 may include an electronic device including a speech processing apparatus 100, a server 300, and a network 400. The electronic device 100 including the speech processing apparatus 100 and the server 300 may be connected to each other in a 5G communication environment.

The speech processing apparatus 100 may receive utterance information of a user, and provide a speech recognition service through recognition and analysis. Here, the speech recognition service may include receiving the utterance information of the user, distinguishing a wake-up word and a spoken utterance from each other, and outputting a speech recognition processing result for the spoken utterance so that the speech recognition processing result may be recognized by the user.

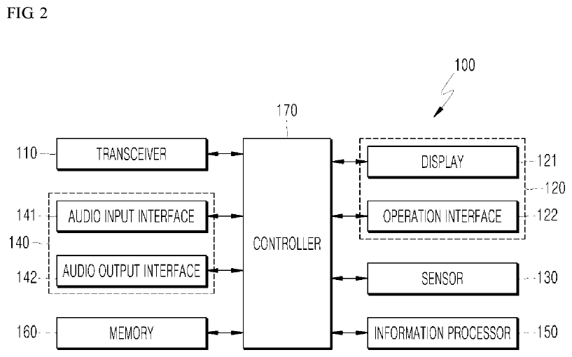

In the present embodiment, utterance information may include a wake-up word and a spoken utterance. The wake-up word is a specific command which activates a speech recognition function of the speech processing apparatus 100. The speech recognition functionality may be activated only when the wake-up word is contained in the spoken utterance, and therefore, when the spoken utterance does not contain the wake-up word, the speech recognition functionality remains in an inactive state (for example, in a sleep mode). The wake-up word may be set in advance to be stored in a memory 160 (see FIG. 2), to be described below.

Further, the spoken utterance may be processed after activating the speech recognition function of the speech processing apparatus 100 by the wake-up word, and may include a voice command which may be actually processed by the speech processing apparatus 100 to generate an output. For example, when the utterance information of the user is “Hi, LG. Turn on the air conditioner.”, the wake-up word may be “Hi, LG.”, and the spoken utterance may be “Turn on the air conditioner.”. The speech processing apparatus 100 may determine presence of the wake-up word from the utterance information of the user, and may control an air conditioner 205, serving as an electronic device 200, by analyzing the spoken utterance.

In the present embodiment, when the speech recognition function is activated after receiving the wake-up word, the speech processing apparatus 100 may analyze two or more utterance intents from the spoken utterance of the user including two or more commands for operating the electronic device 200, and may operate the electronic device 200 in response to the analyzed two or more utterance intents.

To this end, the speech processing apparatus 100 may perform encoding for generating a keyword mapping text in which a plurality of words are respectively mapped to preset keywords by using user utterance text consisting of the plurality of words as an input.

Before performing the encoding, the speech processing apparatus 100 may convert the spoken utterance of the user including a command for commanding two or more operations of the electronic device 200 into the user utterance text, and may classify the user utterance text into words by tokenizing the user utterance text.

The speech processing apparatus 100 may generate attention information about each of the keywords by inputting the keyword mapping text into an attention model.

The speech processing apparatus 100 may perform decoding for outputting two or more utterance intents corresponding to the user utterance text by using the attention information.

After performing the decoding, the speech processing apparatus 100 may operate the electronic device 200 in response to a command for commanding two or more operations included in the user utterance text. For example, when the user spoken utterance is “Rinse twice and dry for 5 minutes”, the speech processing apparatus 100 may determine a washing machine 203 as a domain, and from the user spoken utterance may analyze the intent to be rinsing and drying. Thereafter, rinsing and drying operations of the washing machine 203 may be performed.

In the present embodiment, the speech processing apparatus 100 may be included in the electronic device 200. The electronic device 200 may include various devices corresponding to Internet of Things (IoT) devices, such as a user terminal 201, an artificial intelligence speaker 202 serving as a hub which connects other electronic devices to the network 400, a washing machine 203, a robot cleaner 204, an air conditioner 205, and a refrigerator 206. However, the electronic device 200 is not limited to the examples illustrated in FIG. 1.

The user terminal 201 of the electronic device 200 may access a speech processing device driving application or a speech processing device driving site and then receive a service for driving or controlling the speech processing apparatus 100 through an authentication process. In the present embodiment, the user terminal 201 on which the authentication process has been completed may operate the speech processing apparatus 100 and control an operation of speech processing apparatus 100.

In the present embodiment, the user terminal 201 may be a desktop computer, smartphone, notebook, tablet PC, smart TV, cell phone, personal digital assistant (PDA), laptop, media player, micro server, global positioning system (GPS) device, electronic book terminal, digital broadcast terminal, navigation device, kiosk, MP3 player, digital camera, home appliance, and other mobile or immobile computing devices operated by the user, but is not limited thereto. Furthermore, the user terminal 201 may be a wearable terminal having a communication function and a data processing function, such as a watch, glasses, a hairband, a ring, or the like. The user terminal 201 is not limited to the above-mentioned devices, and thus any terminal that supports web browsing may be used as the user terminal 300.

The server 300 may be a database server which provides big data required to apply various artificial intelligence algorithms and data for operating the speech processing apparatus 100. In addition, the server 300 may include a web server or an application server which remotely controls the operation of the speech processing apparatus 100 using a speech processing apparatus driving application or a speech processing apparatus driving web browser installed in the user terminal 201.

Here, artificial intelligence (AI) is an area of computer engineering science and information technology that studies methods to make computers mimic intelligent human actions such as reasoning, learning, self-improving, and the like.

In addition, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of AI that includes the field of study that gives computers the capability to learn without being explicitly programmed. Specifically, machine learning may be a technology for researching and constructing a system for learning, predicting, and improving its own performance based on empirical data and an algorithm for the same. Machine learning algorithms, rather than only executing rigidly set static program commands, may be used to take an approach that builds models for deriving predictions and decisions from inputted data.

The server 300 may receive the spoken utterance of the user from the speech processing apparatus 100, and convert the spoken utterance into the user utterance text. The server 300 may analyze a domain to which the user utterance text belongs and two or more intents of the user utterance text by performing encoding, attention information generation, and decoding on the user utterance text. Here, the server 300 may execute a machine learning algorithm to analyze the domain and intents with respect to the user utterance text. In the present embodiment, the server 300 may transmit the above-mentioned processing result to the speech processing apparatus 100.

According to the processing capability of the speech processing apparatus 100, at least a part of the above-mentioned conversion into the user utterance text and analysis of the domain and intents may be performed by the speech processing apparatus 100.

The network 400 may serve to connect the electronic device 200 including the speech processing apparatus 100 and the server 300 to each other. The network 400 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples. Furthermore, the network 400 may transmit/receive information using short-range communications and/or long-distance communications. The short distance communication may include Bluetooth®, radio frequency identification (RFID), infrared data association (IrDA), ultra-wideband (UWB), ZigBee, and Wi-Fi (wireless fidelity) technologies, and the long distance communication may include code division multiple access (CDMA), frequency division multiple access (FDMA), time division multiple access (TDMA), orthogonal frequency division multiple access (OFDMA), and single carrier frequency division multiple access (SC-FDMA).

The network 400 may include a connection of network elements such as a hub, a bridge, a router, a switch, and a gateway. The network 400 may include one or more connected networks, including a public network such as the Internet and a private network such as a secure corporate private network. For example, the network may include a multi-network environment. Access to the network 400 can be provided via one or more wired or wireless access networks. Furthermore, the network 400 may support the Internet of things (IoT) for 5G communication or exchanging and processing information between distributed elements such as objects.

FIG. 2 is a schematic block diagram of a speech processing apparatus according to an exemplary embodiment of the present disclosure. In the following description, a repeated description of FIG. 1 will be omitted. Referring to FIG. 2, the speech processing apparatus 100 may include a transceiver 110, a user interface 120 including a display 121 and an operation interface 122, a sensor 130, an audio processor 140 including an audio input interface 141 and an audio output interface 142, an information processor 150, a memory 160, and a controller 170.

The transceiver 110 may interwork with the network 400 to provide a communication interface required to provide a transmitted/received signal between the speech processing apparatus 100 and/or the electronic devices 200 and/or the server 300 in the form of packet data. Moreover, the transceiver 110 may serve to receive a predetermined information request signal from the electronic device 200 and also serve to transmit information processed by the speech processing apparatus 100 to the electronic device 200. Further, the transceiver 110 may transmits the predetermined information request signal from the electronic device 200 to the server 300 and receive a response signal processed by the server 300 to transmit the signal to the electronic device 200. Further, the transceiver 110 may be a device including hardware and software required to transmit and receive a signal such as a control signal or a data signal, through wired/wireless connection with other network devices.

Further, the transceiver 110 may support various kinds of object intelligence communications (such as Internet of things (IoT), Internet of everything (IoE), and Internet of small things (IoST)) and may support communications such as machine to machine (M2M) communication, vehicle to everything communication (V2X), and device to device (D2D) communication.

The display 121 of the user interface 120 may display an operation state of the speech processing apparatus 100 under the control of the controller 170. According to an exemplary embodiment, the display 121 may form a mutual layered structure with a touch pad to be configured as a touch screen. In this case, the display 121 may also be used as the operation interface 122 to which information may be input by the touch of the user. To this end, the display 121 may be configured by a touch recognition display controller or other various input/output controllers. As an example, the touch-sensitive display controller may provide an output interface and an input interface between the apparatus and the user. The touch recognition display controller may transmit and receive an electrical signal to and from the controller 170. Also, the touch-sensitive display controller may display visual output to the user, and the visual output may include texts, graphics, images, videos, and combination thereof. Such a display 121 may be a predetermined display member such as an organic light emitting display (OLED), a liquid crystal display (LCD), or a light emitting display (LED) which is capable of recognizing the touch.

The operation interface 122 of the user interface unit 120 may include a plurality of operation buttons (not illustrated) to transmit a signal corresponding to an input button to the controller 170. Such an operation interface 122 may be configured as a sensor, a button, or a switch structure which recognizes a touch or a pressing operation of the user. In the present embodiment, the operation interface 122 may transmit to the controller 170 an operation signal operated by the user in order to check or modify various information related to the operation of the speech processing apparatus 100 displayed on the display 121.

The sensor 130 may include various sensors configured to sense the surrounding situation of the speech processing apparatus 100, such as a proximity sensor (not illustrated) and an image sensor (not illustrated). The proximity sensor may obtain position data of an object (for example, a user) which is located in the vicinity of the speech processing apparatus 100 by utilizing infrared rays. The user's position data obtained by the proximity sensor may be stored in the memory 160.

The image sensor may include a camera capable of photographing the surrounding of the speech processing apparatus 100, and for more efficient photographing, a plurality of image sensors may be provided. For example, the camera may include at least one optical lens, an image sensor (for example, a CMOS image sensor) configured to include a plurality of photodiodes (for example, pixels) on which an image is formed by light passing through the optical lens, and a digital signal processor (DSP) which configures an image based on signals outputted from the photodiodes. The digital signal processor may generate not only a still image, but also a moving image formed by frames configured by a still image. In the meantime, the image photographed by the camera serving as the image sensor may be stored in the memory 160.

In the present embodiment, although the sensor 130 is described as the proximity sensor and the image sensor, the exemplary embodiment is not limited thereto. The sensor 130 may include any sensors capable of sensing the surrounding situation of the speech processing apparatus 100, for example, including at least one of a Lidar sensor, a weight sensing sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor, a microphone, a battery gauge, an environment sensor (for example, a barometer, a hygrometer, a thermometer, a radiation sensor, a thermal sensor, or a gas sensor), and a chemical sensor (for example, an electronic nose, a healthcare sensor, or a biometric sensor). In the exemplary embodiment, the speech processing apparatus 100 may combine and utilize information sensed by at least two sensors from the above-mentioned sensors.

The audio input interface 141 of the audio processor 140 may receive the user's utterance information (for example, a wake-up word and spoken utterance) and transmit the utterance information to the controller 170, and the controller 170 may transmit the user's utterance information to the information processor 150. To this end, the audio input interface 141 may include one or more microphones (not illustrated). Further, a plurality of microphones (not illustrated) may be provided to more accurately receive the uttering speech of the user. Here, the plurality of microphones may be disposed to be spaced apart from each other in different positions and process the received uttering speech of the user as an electrical signal.

As a selective embodiment, the audio input interface 141 may use various noise removing algorithms to remove noises generated in the middle of reception of the uttering speech of the user. As a selective embodiment, the audio input interface 141 may include various components for processing the voice signal, such as a filter (not illustrated) which removes the noise at the time of receiving the uttering speech of the user and an amplifier (not illustrated) which amplifies and outputs a signal output from the filter.

The audio output interface 142 of the audio processor 140 may output a notification message such as an alarm, an operation mode, an operation state, or an error state, response information corresponding to the utterance information of the user, and a processing result corresponding to the spoken utterance (voice command) of the user as audio, in accordance with the control of the controller 170. The audio output interface 142 may convert the electrical signal from the controller 170 into an audio signal to output the audio signal. To this end, the audio output interface may include a speaker or the like.

When the speech recognition function is activated after receiving the wake-up word, the information processor 150 may convert the spoken utterance of the user including a voice command into the user utterance text. The information processor 150 may classify the user utterance text into a plurality of words by tokenizing the user utterance text.

The information processor 150 may perform encoding for generating a keyword mapping text in which a plurality of words are respectively mapped to preset keywords by using a user utterance text consisting of the plurality of words as an input.

The information processor 150 may generate attention information about each of the keywords by inputting the keyword mapping text into an attention model.

The information processor 150 may perform decoding for outputting two or more utterance intents corresponding to the user utterance text by using the attention information. In addition, the information processor 150 may perform grammatical analysis or semantic analysis on the user utterance text to analyze a domain to which the user utterance text belongs.

After performing the decoding, the information processor 150 may transmit a command for commanding two or more operations included in the user utterance text to the controller 170, and the controller 170 may use the command for commanding the two or more operations to operate the electronic device 200.

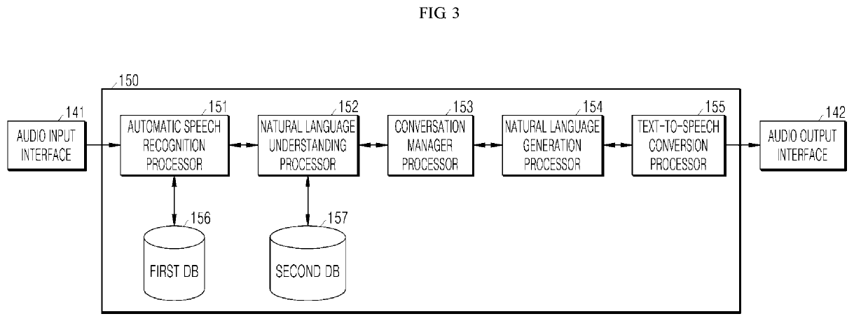

In the present embodiment, the information processor 150 may be connected to the controller 170 to perform learning, or receive the learning result from the controller 170. In the present embodiment, the information processor 150 may be equipped at the outside of the controller 170 as illustrated in FIG. 2 or equipped in the controller 170 to operate as the controller 170, or provided in the server 300 of FIG. 1. Hereinafter, details of the information processor 150 will be described with reference to FIGS. 3 and 5.

The memory 160, which may store various information required for the operation of the speech processing apparatus 100 and store control software capable of operating the speech processing apparatus 100, may include a volatile or nonvolatile recording medium. For example, in the memory 160, a predetermined wake-up word for determining the presence of the wake-up word from the spoken utterance of the user may be stored. The wake-up word may be set by a manufacturer. For example, “Hi. LG” may be set as the wake-up word, and the user may change the wake-up word. The wake-up word may be inputted to activate the speech processing apparatus 100, and the speech processing apparatus 100 which recognizes the wake-up word uttered by the user may be switched to a speech recognition active state.

Further, the memory 160 may store utterance information (wake-up word and spoken utterance) of the user received by the audio input interface 141, information sensed by the sensor 130, and information processed by the information processor 150.

In addition, the memory 160 may store a command to be executed by the information processor 150, for example, a command for converting the user's spoken utterance including a voice command into user utterance text, an encoding command for generating a keyword mapping text in which a plurality of words are respectively mapped to preset keywords by using the user utterance text consisting of the plurality of words as input, a command for generating attention information about each of the keywords by inputting the keyword mapping text into an attention model, a decoding command for outputting two or more utterance intents corresponding to the user utterance text by using the attention information, a command for operating the electronic device 200 in response to a command for commanding two or more operations included in the user utterance text after performing the decoding, and the like. Furthermore, the memory 160 may store various information processed by the information processor 150.

Herein, the memory 160 may include magnetic storage media or flash storage media, but the scope of the present disclosure is not limited thereto. The memory 160 may include an internal memory and/or an external memory and may include a volatile memory such as a DRAM, a SRAM or a SDRAM, and a non-volatile memory such as one-time programmable ROM (OTPROM), a PROM, an EPROM, an EEPROM, a mask ROM, a flash ROM, a NAND flash memory or a NOR flash memory, a flash drive such as an SSD, a compact flash (CF) card, an SD card, a Micro-SD card, a Mini-SD card, an XD card or memory stick, or a storage device such as a HDD.

Here, simple speech recognition may be performed by the speech processing apparatus 100, and high-level speech recognition such as natural language processing may be performed by the server 300. For example, when a word uttered by the user is a predetermined wake-up word, the speech processing apparatus 100 may be switched to a state for receiving utterance information as a voice command. In this case, the speech processing apparatus 100 may perform only the speech recognition process for checking whether the wake-up word speech is inputted, and the speech recognition for the subsequent uttering sentence may be performed by the server 300. Since system resources of the speech processing apparatus 100 are limited, complex natural language recognition and processing may be performed by the server 300.

The controller 170 may transmit utterance information received through the audio input interface 141 to the information processor 150, and provide the speech recognition processing result from the information processor 150 through the display 121 as visual information or provide the speech recognition processing result through the audio output interface 142 as auditory information.

The controller 170 is a sort of central processor, and may drive control software installed in the memory 160 to control an overall operation of the speech processing apparatus 100. The controller 170 may include any types of devices which are capable of processing data such as a processor. Here, the “processor” may, for example, refer to a data processing device embedded in hardware, which has a physically structured circuitry to perform a function represented by codes or instructions contained in a program. As examples of the data processing device embedded in hardware, a microprocessor, a central processor (CPU), a processor core, a multiprocessor, an application-specific integrated circuit (ASIC), and a field programmable gate array (FPGA) may be included, but the scope of the present disclosure is not limited thereto.

In the present embodiment, the controller 170 may perform machine learning such as deep learning on the spoken utterance of the user so as to enable the speech processing apparatus 100 to output an optimal speech recognition processing result. The memory 160 may store, for example, data used in the machine learning and result data.

Deep learning technology, which is a subfield of machine learning, enables data-based learning through multiple layers. Deep learning may represent a set of machine learning algorithms that extract core data from a plurality of data sets as the number of layers in increases.

Deep learning structures may include an artificial neural network (ANN), and may include deep neural networks such as a convolutional neural network (CNN), a recurrent neural network (RNN), a deep belief network (DBN), and the like. In the present embodiment, the deep learning structure may use a variety of structures well known to those skilled in the art. For example, the deep learning structure according to the present disclosure may include a CNN, an RNN, a DBN, and the like. RNN is heavily used in natural language processing and the like, and may configure an ANN structure by building up layers at each instance with a structure effective for processing time-series data which vary over a course of time. The DBN may include a deep learning structure that is constructed by stacking the result of restricted Boltzman machine (RBM) learning in multiple layers. A DBN has the number of layers formed by repeating RBM training. A CNN may include a model mimicking a human brain function, built under the assumption that when a person recognizes an object, the brain extracts the most basic features of the object and recognizes the object based on the results of complex processing in the brain.

Further, the ANN may be trained by adjusting weights of connections between nodes (if necessary, adjusting bias values as well) so as to produce a desired output from a given input. Also, the ANN can continuously update the weight values through learning. Furthermore, methods such as back propagation may be used in training the ANN.

As described above, the controller 170 may be provided with an artificial neural network and perform machine learning-based user recognition and user's voice recognition using received audio input signals as input data.

The controller 170 may include an ANN, for example, a deep neural network (DNN) and train the DNN, and examples of the DNN include CNN, RNN, DBN, and so forth. As a machine learning method for such an ANN, both unsupervised learning and supervised learning may be used. The controller 170 may control to have a speech recognition ANN structure to be updated after learning.

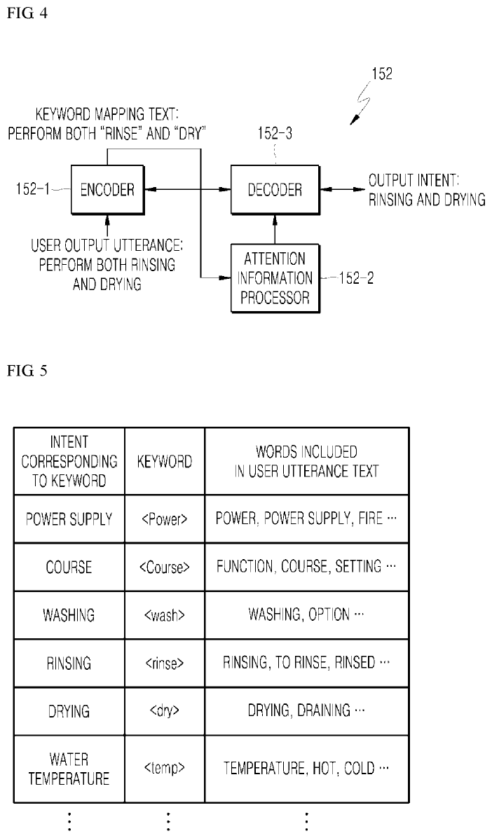

FIG. 3 is a schematic block diagram of an information processor according to an exemplary embodiment of the speech processing apparatus of FIG. 2. FIG. 4 is a schematic block diagram of a natural language understanding unit according to an exemplary embodiment of the information processor of FIG. 3. FIG. 5 is an exemplary view illustrating setting of information stored in a second database of the information processor of FIG. 3. In the following description, repeated description of FIGS. 1 to 2 will be omitted.

Referring to FIG. 3, the information processor 150 may include an automatic speech recognition processor 151, a natural language understanding processor 152, a conversation manager processor 153, a natural language generation processor 154, a text-to-speech conversion processor 155, a first database 156, and a second database 157. As a selective embodiment, the information processor 150 may include one or more processors. As a selective embodiment, the automatic speech recognition processor 151 to the second database 157 may correspond to the one or more processors. As a selective embodiment, the automatic speech recognition processor 151 to the second database 157 may correspond to software components configured to be executed by the one or more processors.

The automatic speech recognition processor 151 may generate a user utterance text obtained by converting the user's spoken utterance including a voice command into text. Here, the spoken utterance of the user may include a command for commanding two or more operations of the electronic device 200. For example, when the electronic device 200 is the washing machine 203, the command for commanding two or more operations included in the spoken utterance of the user may include “Perform both rinsing and drying”. In addition, when the electronic device 200 is a clothing treatment device (not illustrated), the command may include “Dust off and steam the clothes”.

In the present embodiment, the automatic speech recognition processor 151 may perform speech-to-text (STT) conversion. The automatic speech recognition processor 151 may convert a user spoken utterance inputted via the audio input interface 141 into user utterance text. In the present embodiment, the automatic speech recognition processor 151 may include an utterance recognizer (not illustrated). The utterance recognizer may include an acoustic model and a language model. For example, the acoustic model may include vocalization-related information, and the language model may include unit phoneme information and information about combination of the unit phoneme information. The utterance recognizer may use the vocalization-related information and the unit phoneme information to convert a user spoken utterance into user utterance text. Information about the acoustic model and the language model may be stored in the first database 156, that is, an automatic speech recognition database.

The natural language understanding processor 152 may perform encoding for generating a keyword mapping text in which a plurality of words are respectively mapped to preset keywords by using a user utterance text consisting of the plurality of words as an input. The natural language understanding processor 152 may generate attention information about each of the keywords by inputting the keyword mapping text into an attention model. The natural language understanding processor 152 may perform decoding for outputting two or more utterance intents corresponding to the user utterance text by using the attention information.

Referring to FIG. 4, the natural language understanding processor 152 may include an encoder 152-1, an attention information processor 152-2, and a decoder 152-3.

The encoder 152-1 may generate and output a keyword mapping text in which a plurality of words are respectively mapped to preset keywords stored in the second database 157 by using a user utterance text consisting of the plurality of words as an input.

In the present embodiment, the second database 157 may store keywords to be mapped to correspond to the words included in the user utterance text. Here, intents corresponding to the keywords may be designated.

For example, when the user utterance text includes words such as “rinsing”, “to rinse”, “rinsed”, and the like, the encoder 152-1 may access the second database 157 and select “rinse” as a keyword, and then map the keyword “rinse” to the corresponding words of the user utterance text.

In addition, when the user utterance text includes words such as “drying”, “draining”, and the like, the encoder 152-1 may access the second database 157 and select “dry” as a keyword, and then map the keyword “dry” to the corresponding words of the user utterance text.

Therefore, when the utterance text of the user is “Perform both rinsing and drying”, the encoder 152-1 may map the keyword “rinse” to a rinse position and map the keyword “dry” to a dry position, and thereby generate and output “Perform both ‘rinse’ and ‘dry’” as the keyword mapping text.

As a selective embodiment, the encoder 152-1 may output a keyword corresponding to a word included in the user utterance text by using a first deep neural network model that is pre-trained to output multiple words indicating the same meaning as a keyword corresponding to the meaning, and may generate and output a keyword mapping text in which a plurality of words included in the user utterance text are respectively mapped to keywords.

Through such keyword mapping text generation of the encoder 152-1, more pieces of feature information may be transmitted to the decoder 152-3, thereby improving intent output performance of the decoder 152-3.

The attention information processor 152-2 may generate attention information about each of the keywords by inputting the keyword mapping text into an attention model (not illustrated). The attention model may indicate a model for generating attention information corresponding to keyword feature information by using a pre-trained neural network. Here, the attention information may be information indicating which intent among two or more intents outputted after a decoding process is required to be assigned a weight.

For example, the attention model may use, in an RNN encoder-decoder model, encoding generated using a hidden state of the encoder 152-1 and a hidden state of the decoder 152-3 generated up to the present as an input, to determine a position (keyword) to be carefully watched during the input. The attention model may assign a higher weight (attention information) to the position (keyword) to be watched carefully. That is, the attention model may output different attention information for each keyword according to the position of a keyword which has played an important role in generating a current output.

The decoder 152-3 may perform decoding for outputting two or more utterance intents corresponding to the user utterance text outputted by the encoder 152-1 by using the attention information outputted by the attention information processor 152-2.

In the present embodiment, the decoder 152-3 may be configured to output two or more utterance intents corresponding to the user utterance text from the keyword mapping text reflecting the attention information by using a second deep neural network that is pre-trained to output an utterance intent corresponding to the user utterance text from the user utterance text to which keywords are mapped.

In the present embodiment, a case may arise in which the encoder 152-1 is unable to map a word included in the user utterance text to a keyword stored in the second database 157. In a case in which words including “squeeze out water” or “wash in water” are present in the user utterance text, for example, this may be due to absence of a keyword corresponding to the words. In this case, the encoder 152-1 may output the user utterance text to the decoder 152-3, and the decoder 152-3 may output an intent without the attention information. Here, the decoder 152-3 may output an utterance intent corresponding to the user utterance text by using a third deep neural network model that is pre-trained to output an utterance intent corresponding to the user utterance text from the user utterance text.

As a selective embodiment, the natural language understanding processor 152 may analyze a domain and intent of the user spoken utterance by performing grammatical analysis or semantic analysis on the user utterance text. Here, the syntactic analysis may divide the query text into syntactic units (for example, words, phrases, and morphemes) and may recognize what grammatical elements the divided units have. In the present embodiment, a technique of classifying the user utterance text into words by tokenizing the user utterance text may be included in the grammatical analysis. In the present embodiment, the natural language understanding processor 152 may further include a first processor (not shown), and may classify the user utterance text the words into words by tokenizing the user utterance text.

Further, the semantic analysis may be performed using, for example, semantic matching, rule matching, or formula matching. In the present embodiment, the domain may include information for designating a product of any one electronic device 200 which the user intends to operate. In addition, in the present embodiment, the intent may include information indicating how the electronic device 200 included in the domain is to be operated. For example, when the user utterance text is “Perform both rinsing and drying”, the natural language processor 152 may output a washing machine as the domain, and rinsing and drying as the intent.

As a selective embodiment, the natural language understanding processor 152 may use a matching rule stored in the second database 157, that is, a natural language understanding database, to analyze the domain and the intent. The natural language understanding processor 152 may analyze the domain by identifying the meaning of a word extracted from the user utterance text using linguistic features (for example, grammatical elements) such as morphemes, phrases, and the like, and matching the identified meaning of the word to a domain. For example, the natural language understanding processor 152 may analyze the domain by calculating how many words extracted from the user utterance text are included in the respective domains.

As a selective embodiment, the natural language understanding processor 152 may utilize a statistical model to analyze the domain and the intent. The statistical model may refer to various types of machine learning models. In the present embodiment, the natural language understanding processor 152 may refer to a domain classifier model for searching for a domain, and may refer to an intent classifier model for searching for an intent.

The conversation manager processor 153 may perform overall control of conversation between the user and the speech processing apparatus 100, and may determine a query text to be generated using a result of understanding the user utterance text received from the automatic speech recognition processor 151, or may cause the natural language generation processor 154 to generate a language text in the language of the user when generating the query text to feed back to the user.

In the present embodiment, the conversation manager processor 153 may determine whether an utterance intent identified by the natural language understanding processor 152 is clear. For example, the conversation manager processor 153 may determine whether the user's utterance intent is clear based on whether information about a slot is sufficient. The conversation manager processor 153 may determine whether the slot identified by the natural language understanding processor 152 is sufficient to perform a task. According to an exemplary embodiment, when the user's utterance intent is not clear, the conversation manager processor 153 may perform a feedback request for requesting necessary information from the user. For example, the conversation manager processor 153 may perform a feedback request for requesting information from the user about a slot for identifying the user's utterance intent.

According to an exemplary embodiment, when the conversation manager processor 153 is able to control operation of the electronic device 200 based on the intent and the slot identified by the natural language understanding processor 152, the conversation manager processor 153 may generate a result of performing a task corresponding to an inputted user utterance.

The natural language generation processor 154 may change designated information into a text form. The information changed into the text form may be in the form of a natural language utterance. The designated information may be, for example, information for controlling an operation of the electronic device 200, information for guiding completion of an operation corresponding to user utterance information, or information for guiding an additional input of a user (for example, information about a feedback request for requesting necessary information from the user).

The text-to-speech conversion unit 155 may convert text generated by the natural language generation processor 154 into a spoken utterance, and output the spoken utterance through the audio output interface 142. In addition, the text-to-speech conversion unit 155 may convert operation completion text of the electronic device 200 generated by the natural language generation processing unit 154 into an operation completion spoken utterance of the electronic device 200, and may feed the operation completion spoken utterance back to the user via the audio output interface 142.

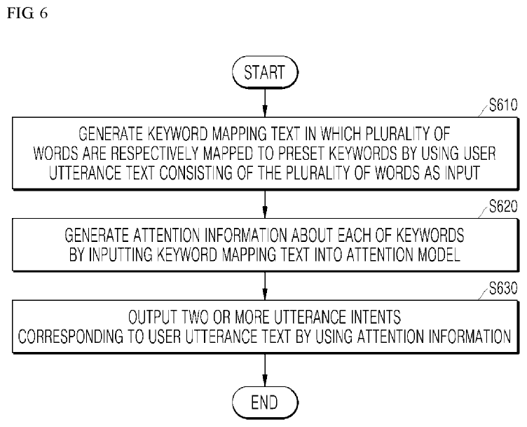

FIG. 6 is a flowchart illustrating a speech processing method according to an exemplary embodiment of the present disclosure. Hereinbelow, a repeated description of the common parts previously described with reference to FIG. 1 through FIG. 5 will be omitted.

Referring to FIG. 6, in step S610, the speech processing apparatus 100 may perform encoding for generating a keyword mapping text in which a plurality of words are respectively mapped to preset words by using user utterance text consisting of the plurality of words as an input. When a speech recognition function is activated after a wake-up word is received, the speech processing apparatus 100 may convert a spoken utterance of a user including a voice command into a user utterance text. In addition, the speech processing apparatus 100 may classify the user utterance text into a plurality of words by tokenizing the user utterance text.

In step S620, the speech processing apparatus 100 may generate attention information about each of the keywords by inputting the keyword mapping text into an attention model. Here, the attention model may indicate a model for generating attention information corresponding to keyword feature information by using a pre-trained neural network. Here, the attention information may be information indicating which intent among two or more intents outputted after a decoding process is required to be assigned a weight.

In step S630, the speech processing apparatus 100 may perform decoding for outputting two or more utterance intents corresponding to the user utterance text by using the attention information. After performing the decoding, the speech processing apparatus 100 may operate the electronic device 200 by using a command for commanding two or more operations included in the user utterance text.

The exemplary embodiments described above may be implemented through computer programs executable through various components on a computer, and such computer programs may be recorded in computer-readable media. In this case, examples of the computer-readable media may include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program instructions, such as ROM, RAM, and flash memory devices.

The computer programs may be those specially designed and constructed for the purposes of the present disclosure or they may be of the kind well known and available to those skilled in the computer software arts. Examples of computer programs may include both machine codes, such as produced by a compiler, and higher-level codes that may be executed by the computer using an interpreter or the like.

As used in the present application (especially in the appended claims), the terms “a/an” and “the” include both singular and plural references, unless the context clearly states otherwise. Also, it should be understood that any numerical range recited herein is intended to include all sub-ranges subsumed therein (unless expressly indicated otherwise) and therefore, the disclosed numeral ranges include every individual value between the minimum and maximum values of the numeral ranges.

Also, the order of individual steps in process claims of the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example,” etc.) used herein are merely to describe the present disclosure in greater detail. Therefore, it should be understood that the scope of the present disclosure is not limited to the exemplary embodiments described above or by the use of such terms unless limited by the appended claims. In addition, technical ideas of the present disclosure can also be readily implemented by those skilled in the art according to various conditions and factors within the scope of the appended claims to which various modifications, combinations, and changes are added, or equivalents thereof.

The present disclosure is thus not limited to the example embodiments described above, and rather intended to include the following appended claims, and all modifications, equivalents, and alternatives falling within the spirit and scope of the following claims.

### DESCRIPTION OF SYMBOLS

100: Speech processing apparatus
200: Electronic device
300: Server
400: Network

1. A speech processing method, comprising:
generating a keyword mapping text in which a plurality of words are respectively mapped to preset keywords by using a user utterance text consisting of the plurality of words as an input;
generating attention information about each of the keywords by inputting the keyword mapping text into an attention model; and
outputting two or more utterance intents corresponding to the user utterance text by using the attention information.

2. The speech processing method according to claim 1, further comprising:
before the generating the keyword mapping text,
converting a spoken utterance of a user including a command for commanding two or more operations of at least one electric device among a plurality of electronic devices into the user utterance text; and
classifying the user utterance text into words by tokenizing the user utterance text.

3. The speech processing method according to claim 2, wherein the generating the keyword mapping text comprises:
outputting a keyword corresponding to a word included in the user utterance text by using a first deep neural network model that is pre-trained to output multiple words indicating a same meaning as a keyword corresponding to the meaning; and
generating the keyword mapping text in which the plurality of words included in the user utterance text are respectively mapped to the keywords.

4. The speech processing method according to claim 1, wherein the generating the attention information comprises generating attention information including information indicating which keyword among the keywords is required to be assigned a higher weight, so as to output two or more speech intents in the outputting the utterance intents.

5. The speech processing method according to claim 1, wherein the outputting the utterance intents comprises outputting two or more utterance intents corresponding to the user utterance text from the keyword mapping text reflecting the attention information by using a second deep neural network that is pre-trained to output an utterance intent corresponding to the user utterance text from the user utterance text to which the keywords are mapped.

6. The speech processing method according to claim 2, further comprising:
after the outputting the utterance intents,
operating the electronic device in response to a command for commanding two or more operations included in the user utterance text.

7. A computer-readable recording medium on which a computer program for executing the method according to claim 1 using a computer is stored.

8. A speech processing apparatus, comprising:
an encoder configured to generate keyword mapping text in which a plurality of words are respectively mapped to preset keywords by using a user utterance text consisting of the plurality of words as an input;
an attention information processor configured to generate attention information about each of the keywords by inputting the keyword mapping text into an attention model; and
a decoder configured to output two or more utterance intents corresponding to the user utterance text by using the attention information.

9. The speech processing apparatus according to claim 8, further comprising:
a first processor configured to, before generating the keyword mapping text, convert a spoken utterance of a user including a command for commanding two or more operations of at least one electric device among a plurality of electronic devices into the user utterance text, and to classify the user utterance text into words by tokenizing the user utterance text.

10. The speech processing apparatus according to claim 9, wherein the encoder is configured to:
output a keyword corresponding to a word included in the user utterance text by using a first deep neural network model that is pre-trained to output multiple words indicating a same meaning as a keyword corresponding to the meaning; and
generate the keyword mapping text in which the plurality of words included in the user utterance text are respectively mapped to the keywords.

11. The speech processing apparatus according to claim 8, wherein the attention information processor is configured to obtain attention information including information indicating which keyword among the keywords is required to be assigned a higher weight, so as to output two or more speech intents by the decoder.

12. The speech processing apparatus according to claim 8, wherein the decoder is configured to output two or more utterance intents corresponding to the user utterance text from the keyword mapping text reflecting the attention information by using a second deep neural network that is pre-trained to output an utterance intent corresponding to the user utterance text from the user utterance text to which the keywords are mapped.

13. The speech processing apparatus according to claim 9, further comprising a controller configured to operate the electronic device in response to a command for commanding two or more operations included in the user utterance text, after the decoder outputs the utterance intents.

14. A speech processing apparatus, comprising:
one or more processors; and
a memory connected to the one or more processors,
wherein the memory stores a command configured to cause the one or more processor to:
generate a keyword mapping text in which a plurality of words are respectively mapped to preset keywords by using user utterance text consisting of the plurality of words as input;
obtain attention information about each of the keywords by inputting the keyword mapping text into an attention model; and
output two or more utterance intents corresponding to the user utterance text by using the attention information.

15. The speech processing apparatus according to claim 14, wherein the command is configured to additionally cause:
conversion of a spoken utterance of a user including a command for commanding two or more operations of at least one electronic device of a plurality of electronic devices into the user utterance text, before generating the keyword mapping text; and
classification of the user utterance text into words by tokenizing the user utterance text.

16. The speech processing apparatus according to claim 14, wherein the command is configured to cause:
output of a keyword corresponding to a word included in the user utterance text by using a first deep neural network model that is pre-trained to output multiple words indicating a same meaning as a keyword corresponding to the meaning, when the keyword mapping text is generated; and
generation of the keyword mapping text in which the plurality of words included in the user utterance text are respectively mapped to the keywords.

17. The speech processing apparatus according to claim 14, wherein the command is configured to cause generation of the attention information including information indicating which keyword among the keywords is required to be assigned a higher weight, so as to output two or more speech intents, when the attention information is generated.

18. The speech processing apparatus according to claim 14, wherein the command is configured to cause output of two or more utterance intents corresponding to the user utterance text from the keyword mapping text reflecting the attention information by using a second deep neural network that is pre-trained to output an utterance intent corresponding to the user utterance text from the user utterance text to which the keywords are mapped, when the utterance intents are outputted.

19. The speech processing apparatus according to claim 15, wherein the command is configured to additionally cause operation of the electronic device in response to a command for commanding two or more operations included in the user utterance text, after the utterance intents are outputted.
